(19) United States
(12) Patent Application Publication
(10) Pub. No.: US 2007/0171911 A1
(43) Pub. Date: Jul. 26, 2007

(54) Routing system and method for managing rule entry thereof

(76) Inventor: Yoon-Jin Ku, Seognam-si (KR)

Correspondence Address: Robert E. Bushnell, Suite 300, 1522 K Street, N.W., Washington, DC, 20005, US

(21) Appl. No.: 11/640,925

(22) Filed: Dec. 19, 2006

(30) Foreign Application Priority Data
Jan. 25, 2006 (KR) 10-2006-0007851

(51) Int. Cl. H04L 12/56

(52) U.S. Cl. 370/392; 370/401

(57) ABSTRACT

In a routing system and a method for managing a rule entry of the routing system, the routing system comprises: a ternary content addressable memory (TCAM) for classifying rule entries into a reference rule entry having both basic information and priority information about a packet to which a rule having a specific priority is applied, and a separate content rule entry having detailed information about a packet to which at least one rule having the same priority is applied, and for storing the classified rule entries; and an auxiliary memory for storing interface bit map information and direction bit map information corresponding to the reference rule entry, and packet forwarding information corresponding to the content rule entry. Accordingly, when at least one rule having the same priority is applied to several interface packets, all rules can be expressed as only two entries, and the TCAM is effective in memory utilization.

### CLAIM OF PRIORITY

This application makes reference to, incorporates the same herein, and claims all benefits accruing under 35 U.S.C. §119 from an application for APPARATUS AND METHOD FOR MANAGING TERNARY CONTENT ADDRESSABLE MEMORY earlier filed in the Korean Intellectual Property Office on the 25^{th} of January 2006 and there duly assigned Serial No. 2006-7851.

### BACKGROUND OF THE INVENTION

1. Technical Field

The present invention relates to a routing system and a method for managing a rule entry thereof.

2. Related Art

In an Internet network environment, a routing lookup operation causes a main bottleneck phenomenon in the performance of a network processor or a router. Due to rapid increase in Internet users, the conventional classful address system has been replaced by a Classless InterDomain Routing (CIDR) system.

The CIDR system is effective in Internet Protocol (IP) address management, but routing lookup gradually becomes difficult and complex due to Longest Prefix Matching (LPM). Drawbacks caused by the LPM are as follows: i) enlargement of a routing table size, ii) increase in Internet traffic, iii) request for higher speedy network link, and iv) difficulty in transferring to a 128-bit IPv6. In order to solve the difficulty in routing lookup caused by the CIDR system, software and hardware methods have been studied.

The software method is mainly a method in which the amount of memory in use is reduced using a compression algorithm, and a high-speed memory such as a cache or a static random access memory (SRAM) is used to improve routing lookup. The software method can produce direct benefits, such as improvement in the performance of a microprocessor, increase in and improved hit rate of a cache, and a faster front side bus (FSB). However, in the software method, there are many algorithms in which, when routing is updated, a wholesale reconstruction must take place. Also, even though the average search efficiency is excellent, the overall search efficiency deteriorates when the tree structure is dense, and in the worst case, memory access operations are required thirty two times.

The hardware method generally involves a method for linearly mapping an IP address to a memory, and a method for implementing a compression algorithm in hardware. The hardware method has an advantage in that routing speed can be improved due to pipelining, and the routing speed does not deteriorate as a result of arithmetic operation or instruction when the hardware is implemented as a micro-processor to port an operation system (OS).

A recent remarkable lookup method based on hardware implementation is one which uses a content addressable memory (CAM). The CAM uses data and searches for an address to which a data related value is assigned, and has the characteristic of performing an XOR operation for comparison at each cell. Unlike the existing random access memory (RAM) structure, the CAM has an associative memory structure in which reading or writing can be performed by comparing external information with stored content. Due to the above characteristic, the CAM is used to embody a search engine, an image processor, or a neural network at a network router.

The CAM can provide information on a port within one clock cycle. In particular, in a ternary CAM (TCAM), which can store information on any “Don't care” value besides “0” and “1,” it is relatively easy to embody the routing lookup up to the LPM. For packet classification, it is required to make reference to a destination IP address, a source IP address, a source/destination port number, and a protocol field (5-tuple). Since comparison of the reference task with various preset packet filtering rules should be performed on each packet, such comparison is more complicated than IP address lookup.

The TCAM can search for lookup results by parallel comparison of a key intended for search with all entries of the TCAM within a very short latency time of 10 to 20 nanoseconds. In the TCAM, since a mask bit string complying with a content bit string exists, it is not required to compare all of the content bit strings with the search key. The TCAM reports entry information, which is first matched with the search key of all entries within the TCAM, as a search result.

In general, the routing system includes a network processor, a TCAM, and an auxiliary memory. The network processor includes an interface, an entry manager, and a lookup processor.

The interface provides entry management information to the entry manager. The entry management information includes rule information for packet classification or packet filtering inputted by a user through a command line interface (CLI), and information for adding/deleting a predetermined rule to/from the TCAM. In this regard, the rule represents forwarding information of a packet transmitted to the routing system. Information included in the rule can be varied as needed by a user. In general, the rule includes a source IP address, a destination IP address, a reception port number, a transmission port number, a protocol type, and packet forwarding information.

When the entry management information provided by the interface is for the purpose of adding a predetermined rule, the entry manager converts the rule inputted by the user into an entry format of the TCAM, and stores the converted rule in the TCAM. When the entry management information provided by the interface is for the purpose of deleting a predetermined rule stored in the TCAM, the entry manager deletes the rule stored in the TCAM.

In the lookup processor, packet forwarding information is obtained through lookup of the TCAM using a received packet itself and interface information (for example, interface identification and direction) on the received packet. The lookup processor filters the packet based on the packet forwarding information, or applies a policy based on the packet classification.

The TCAM stores a plurality of rules, and the auxiliary memory stores forwarding information about the packet corresponding to each rule stored in the TCAM. In general, the auxiliary memory employs a zero bus turnaround (ZBT) SRAM. In this regard, the packet forwarding information includes information on forwarding permission/denial/classification for the packet received by the network processor.

Meanwhile, for high-speed lookup, each rule entry should store fields for distinguishing the rules of the packet classification or the packet filtering. Since bits of the rule fields are not small in size, and the TCAM is limited to size, the manner in which the fields within the TCAM are stored is an important consideration.

In particular, the packet classification or packet filtering rule provides a changeable format within a specific range of the source/destination protocol number of the 5-tuple, and therefore there is a drawback in that, in order to obtain such a range within the TCAM, one or more entries are required to express one rule. Furthermore, many more entries are required to indicate that one rule is applied to ingress or egress traffic of several interfaces.

### SUMMARY OF THE INVENTION

It is an object of the present invention to provide a routing system and a method for managing rule entry of a routing system, in which entry of a ternary content addressable memory (TCAM) is classified into two types, and then a storage part of an auxiliary memory is changed, thereby promoting effective entry management.

A first aspect of the present invention provides a routing system which comprises: a ternary content addressable memory (TCAM) for classifying rule entries into a reference rule entry having both basic information and priority information about a packet to which a rule having specific priority is applied, and a separate content rule entry having detailed information about a packet to which at least one rule having the same priority is applied, and storing the classified rule entries; and an auxiliary memory for storing interface bit map information and direction bit map information corresponding to the reference rule entry, and packet forwarding information corresponding to the content rule entry.

The priority information of the TCAM may be information on priority between packet classification or packet filtering rules to be applied to an ingress or egress interface.

The interface bit map information of the auxiliary memory may be information on at least one of the interfaces to which at least one rule having the same priority as the TCAM is applied.

The direction bit map information of the auxiliary memory may comprise information on whether at least one of the interfaces, to which at least one rule having the same priority as the TCAM is applied, is an egress interface or an ingress interface.

The content rule entry may comprise: an interface ingress bit map indicating whether or not the interface to which the rule is applied processes ingress traffic; and an egress bit map indicating whether or not the interface to which the rule is applied processes egress traffic.

When the interface to which the rule is applied processes the ingress or egress traffic, a bit corresponding to a traffic direction of the interface may be set to a value of “Don't care.”

The routing system may further comprise an entry manager for adding or deleting the reference rule entry or content rule entry of the TCAM.

The routing system may further comprise a lookup processor for obtaining packet forwarding information through TCAM lookup using a received packet and interface information on the received packet.

The routing system may further comprise a user interface for transmitting, to the entry manager and the lookup processor, rule information input for packet classification, packet filtering, and rule generation and deletion from a user.

A second aspect of the present invention provides a ternary content addressable memory (TCAM) which comprises: a reference rule entry having basic information and priority information about a packet to which a rule having specific priority is applied; and a content rule entry having detailed information about a packet to which at least one rule having the same priority as the reference rule entry is applied.

A third aspect of the present invention provides a method for managing a rule entry for routing, the method comprising the steps of: generating a reference rule entry of a ternary content addressable memory (TCAM) having basic information and priority information about a packet to which a rule having specific priority is applied; generating a content rule entry of the TCAM having detailed information about a packet to which at least one rule having the same priority is applied; and storing, in an auxiliary memory, interface bit map information and direction bit map information corresponding to the reference rule entry, and packet forwarding information corresponding to the content rule entry.

The method may further comprise the steps of: when there is a request to add a new rule, generating a search key for the reference rule entry; and looking-up the TCAM using the search key, searching to determine whether or not a matched entry exists, and when the matched entry does not exist, generating the reference rule entry and the content rule entry for the rule requested for addition.

The method may further comprise the steps of: when a request to delete a specific rule is inputted, generating a search key for the reference rule entry; and looking-up the TCAM using the search key, searching to determine whether or not a matched entry exists, updating the reference rule entry and the content rule entry for the rule requested for deletion when the matched entry exists, and deleting the reference rule entry and the content rule entry when all bits of interface and direction bit maps of the entry are “0.”

The method may further comprise the steps of: when a packet for routing lookup is received, generating a search key for the content rule entry; looking-up the TCAM using the search key; and when a matched entry exists, performing forwarding for the received packet depending on forwarding information stored in the auxiliary memory.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings, in which like reference symbols indicate the same or similar components, wherein:

FIG. 1 is a diagram illustrating an entry information search mechanism of a TCAM using a search key and a mask;

FIG. 2 is a diagram illustrating structures of a TCAM and an auxiliary memory in a routing system;

FIG. 3 is a block diagram of a routing system according to the present invention;

FIG. 4 is a diagram illustrating structures of a TCAM and an auxiliary memory corresponding thereto according to the present invention;

FIG. 5 is a flowchart of the operation of generating an entry of a TCAM according to an exemplary embodiment of the present invention;

FIG. 6 is a diagram illustrating the change of a TCAM structure based on generation of an entry according to the present invention;

FIG. 7 is a diagram illustrating the change of a TCAM structure when a rule is added to a TCAM according to the present invention;

FIG. 8 is a flowchart of a lookup process of a routing system according to the present invention;

FIG. 9 is a diagram illustrating a search key structure for lookup according to an exemplary embodiment of the present invention;

FIG. 10 is a flowchart of an operation of deleting an entry of a TCAM according to an exemplary embodiment of the present invention; and

FIG. 11 is a diagram illustrating the change of a TCAM based on deletion of an entry according to the present invention.

### DETAILED DESCRIPTION OF THE INVENTION

Hereinafter, exemplary embodiments of the present invention will be described in detail with reference to the accompanying drawings. In the following description, a detailed description of known functions and configurations incorporated herein has been omitted for conciseness.

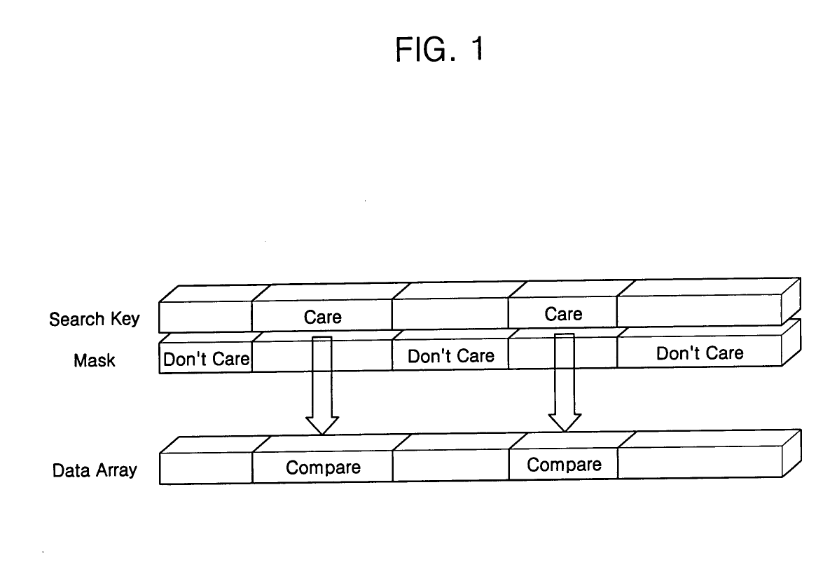

FIG. 1 is a diagram illustrating an entry information search mechanism of a ternary content addressable memory (TCAM) using a search key and a mask.

The TCAM stores the rule in the sequence of low priority, simultaneously compares a given search key with all stored entries, and finds a first matched entry. In this process, since the TCAM has the mask bit string complying with the content bit string, it is not required to compare all of the content bit strings with the search key as described above. In other words, at the time of search, portions which have a “Don't care” value among mask portions of FIG. 1 need not to be considered. Only with regard to the mask portions other than the portions having the “Don't care” value in the search key, the result values obtained by comparison with the content bit string are represented as comparison results, “Compare” values, of data array portions of FIG. 1.

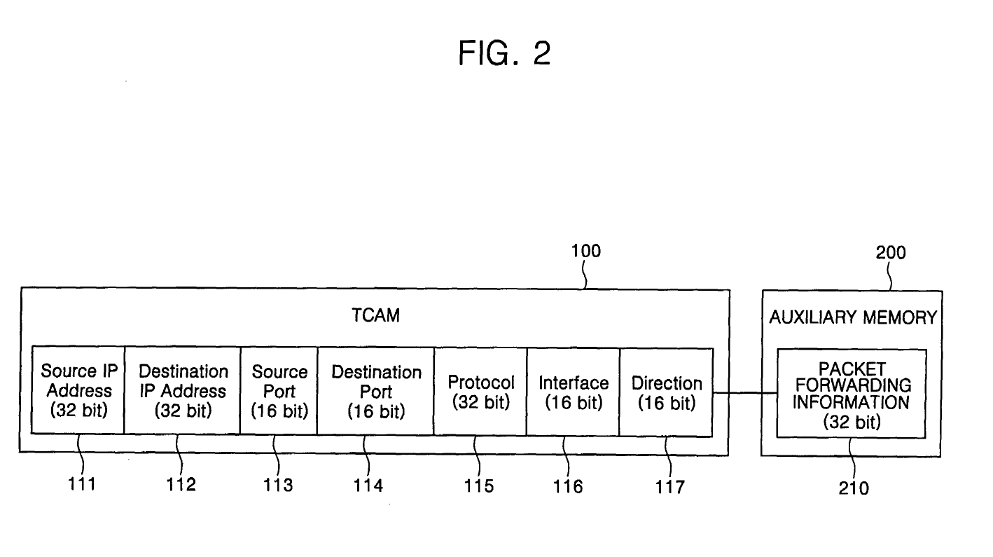

FIG. 2 is a diagram illustrating structures of a TCAM and an auxiliary memory in a routing system.

As illustrated in FIG. 2, a rule of the TCAM 100 corresponds to packet forwarding information of the auxiliary memory 200. It can be confirmed that each rule entry stored in the TCAM 100 includes a 5-tuple typically required for packet classification or packet filtering, that is, a source Internet protocol (IP) address 111, a destination IP address 112, a reception port number 113, a transmission port number 114, and a protocol type 115. Each rule entry also includes interface information to which the rule is applied, for example, interface identification (ID) 116, and direction 117. This is directed in order to take into consideration not only the case where the rule is applied to an entire routing system, but also the case where the rule is discretely applied to ingress or egress traffic of a specific interface. If the rule entry includes only the 5-tuple, after TCAM lookup for the received packet, the lookup processor of the routing system obtains the packet forwarding information, and therefore a separate process for confirming whether or not the packet forwarding information is applied to the interface is required. Accordingly, in order to reduce the time taken for the separate process and to implement high-speed lookup, in general, the rule entry includes information on the 5-tuple and the interface which is a rule application target.

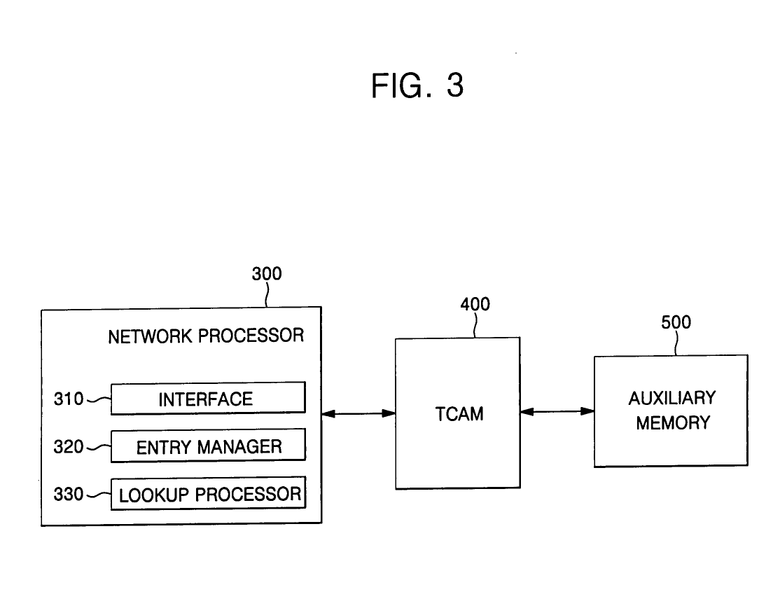

FIG. 3 is a block diagram of a routing system according to the present invention.

As illustrated in FIG. 3, the routing system includes a network processor 300, a TCAM 400, and an auxiliary memory 500. The network processor 300 includes an interface 310, an entry manager 320, and a lookup processor 330.

The interface 310 provides entry management information to the entry manager 320. The entry management information includes rule information for packet classification or packet filtering which is inputted by a user, and information for adding/deleting an arbitrary rule to/from the TCAM 400.

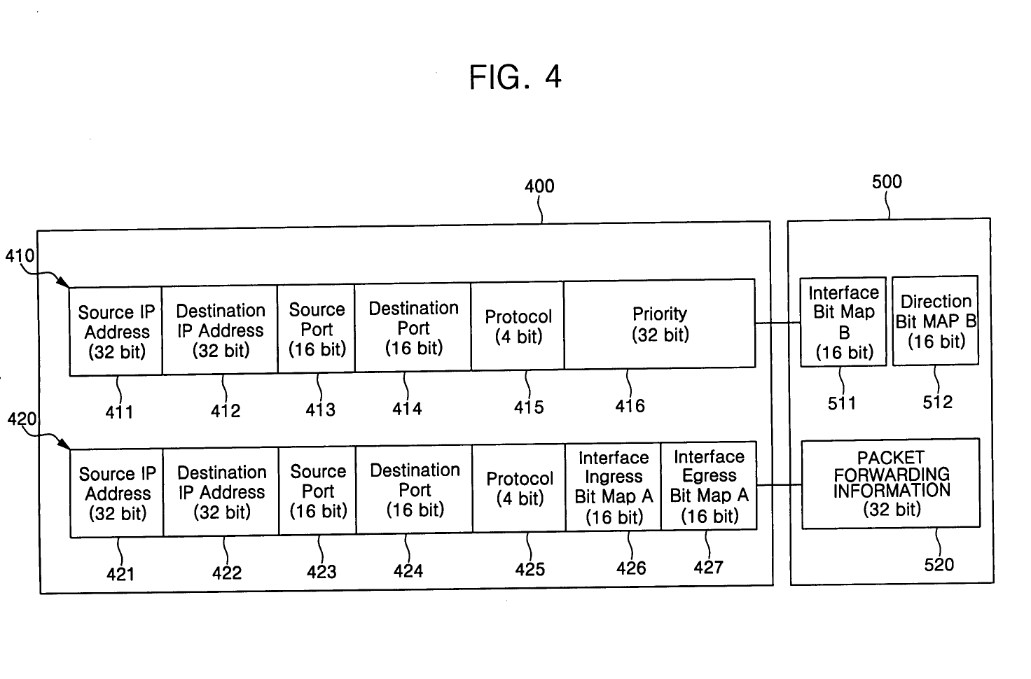

When the entry management information provided by the interface 310 is information for adding the arbitrary rule, the entry manager 320 converts a rule inputted by the user into an entry format of the TCAM 400, and stores the converted rule in the TCAM 400. When the entry management information provided by the interface 310 is information for deleting the arbitrary rule stored in the TCAM 400, the entry manager 320 deletes the rule stored in the TCAM 400. The search key, which the entry manager 320 uses to search for generating, adding or deleting the rule, is one for a reference rule entry. The reference rule entry will be described in detail with reference to FIG. 4.

In the lookup processor 330, packet forwarding information is obtained through lookup from the TCAM 400 using a received packet itself and interface information on the received packet. The search key used by the lookup processor 330 is a search key for a content rule entry. The content rule entry will be described below in detail.

The TCAM 400 includes the reference rule entry and the content rule entry, and the auxiliary memory 500 stores forwarding information of a packet corresponding to each rule stored in the TCAM. Structures of the TCAM 400 and the auxiliary memory 500 will be described below in more detail.

FIG. 4 is a diagram illustrating structures of a TCAM and an auxiliary memory corresponding thereto according to the present invention.

The routing system of the present invention is substantially different from a conventional routing system in structure of a TCAM and an auxiliary memory. In FIG. 4, in order to describe the structures of the TCAM 400 and the auxiliary memory 500 in detail, only the structures of the TCAM and the auxiliary memory are illustrated apart from other structures of the routing system.

A rule entry stored in the TCAM 400 according to the present invention is classified into two types: one for a reference rule entry 410, and the other for a content rule entry 420. The reference rule entry 410 represents an entry format when a 5-tuple, which is a rule for the packet classification or the packet filtering having the same priority, is initially generated and stored in the TCAM. In contrast, the content rule entry 420 serves to store rule entries corresponding to priority of the reference rule entry 410.

Like a general rule entry, the reference rule entry 410 includes a field relating to a source Internet protocol (IP) address 411, a destination IP address 412, a reception port number 413, a transmission port number 414, and a protocol type 415. However, unlike the general rule entry, the reference rule entry 410 does not include an interface field and a direction field, and includes a priority field 416. In the present invention, the priority field 416 is set to 32 bits, and represents priority between the rules for the packet classification or packet filtering applied to an ingress or egress interface.

The auxiliary memory 500 stores information relating to an interface bit map 511 and a direction bit map 512. The information of the interface bit map 511 and direction bit map 512 indicates set information in which a rule having the same priority is applied to several interfaces and directions. In the interface bit map 511, 16 bits are each set to indicate one interface. If the bit has a value of zero, it means that the 5-tuple is not applied to the interface. If the interface bit has a value of 1, it means that the 5-tuple is applied to the interface. In FIG. 4, because the 16 bits are assigned to the interface bit map 511, a total of 16 interfaces are only expressed. However, the expressed interfaces can be adjusted by increasing or decreasing the number of interface bit maps according to a network characteristic.

Each bit of the direction bit map 512 corresponds to each bit of the interface bit map 511, and the interface direction information on bit 0 of the interface bit map 511 represents bit 0 of the direction bit map 512. If each bit of the direction bit map has a value of “0,” the 5-tuple is applied to ingress traffic, and if each bit of the direction bit map has a value of 1, the 5-tuple is applied to egress traffic.

The content rule entry 420 includes the 5-tuple 421, 422, 423, 424, and 425, an interface ingress bit map 426, and an interface egress bit map 427. The interface ingress bit map 426 and the interface egress bit map 427 represent whether the 5-tuple is applied to the ingress traffic or the egress traffic of any interface. If a specific ingress bit has a value of “Don't care,” it is represented that the rule is applied to the ingress traffic of the interface, and if a specific egress bit has a value of “Don't care,” it is represented that the rule is applied to the egress traffic of the interface. If any bit of the interface ingress bit map 426 or the interface egress bit map 427 has the value of “0,” this means that the rule is not applied to the interface. Packet forwarding information 520 is stored in the auxiliary memory 500 with respect to the content rule entry 420. The packet forwarding information 520 is information for forwarding the received packet to which the rule is applied.

If the TCAM and auxiliary memory structures of FIG. 4 are used, only two rule entries are needed for sixteen interfaces to which the rule having the same priority is applied. This is an effective memory space utilization method, compared to a conventional method in which sixteen rule entries are needed for sixteen interfaces.

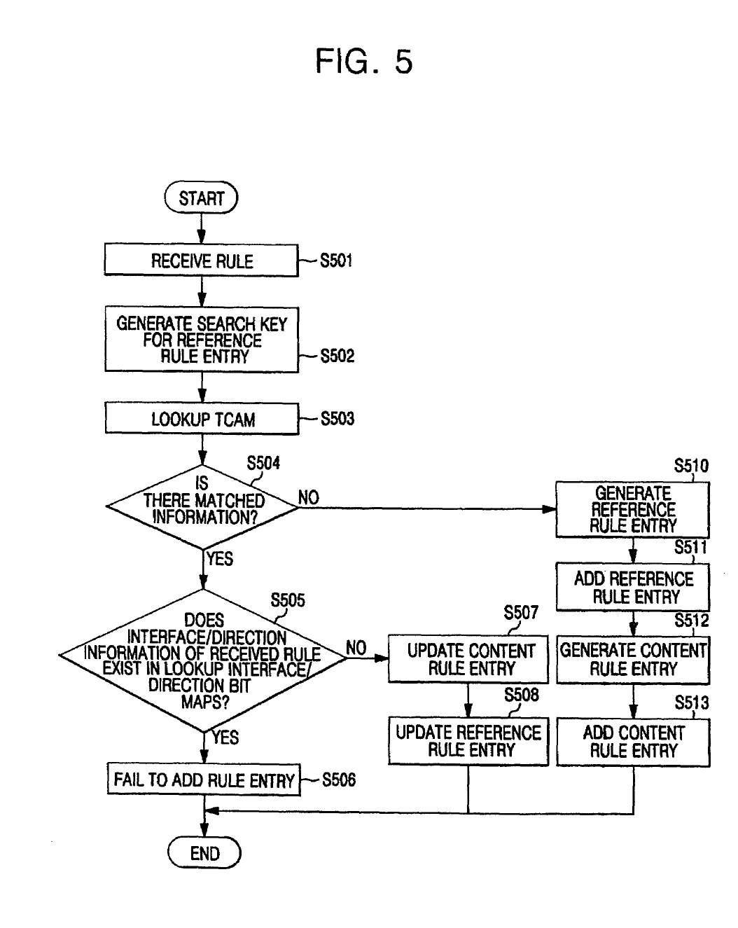

FIG. 5 is a flowchart of the operation of generating an entry of a TCAM according to an exemplary embodiment of the present invention.

When the routing system receives a new rule (Step 501), it generates a search key for the reference rule entry (Step 502). The routing system looks up the TCAM using the generated search key (Step 503), and searches to determine whether or not a matched entry exists (Step 504). If the matched information exists, it is determined whether or not interface and direction information of the received rule exist in the looked-up interface bit map and direction bit map (Step 505). When it is determined that the interface and direction bit maps exist, it is not necessary to add or update the new rule. Hence, a rule entry addition failure message is transmitted (Step 506), and then the process is terminated.

When it is determined in Step 505 that the interface and direction information of the received rule does not exist in the looked-up interface bit map and direction bit map, the content rule entry is updated (Step 507), and the reference rule entry is also updated (Step 508).

If it is determined in Step 504 that matched information does not exist, the reference rule entry conforming to the received rule is generated (Step 510), and it is added to the TCAM (Step 511). The content rule entry corresponding to the reference rule entry is then generated (Step 512), and is added to the TCAM (Step 513).

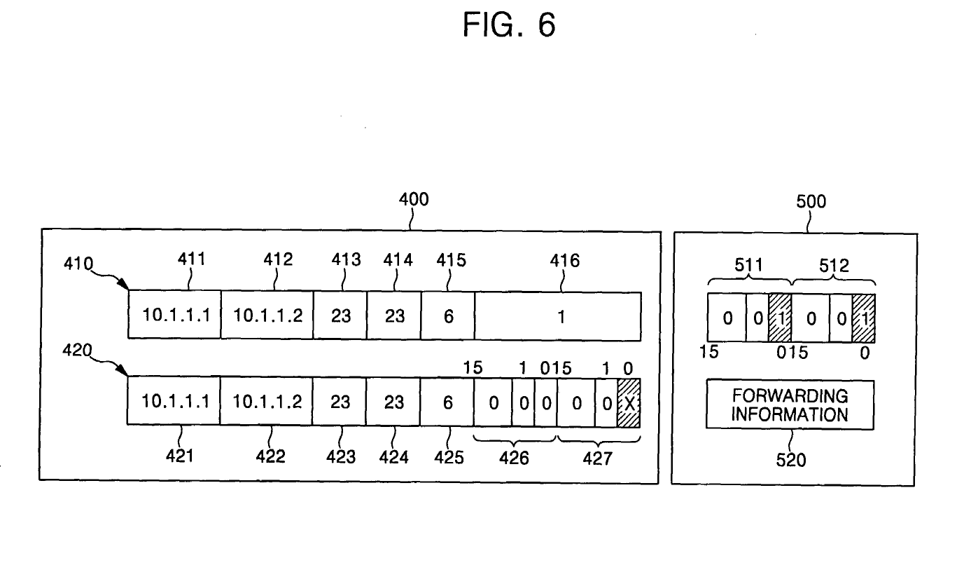

FIG. 6 is a diagram illustrating the change of a TCAM structure based on generation of an entry according to the present invention.

Initially, it is assumed that an interface of the routing system receives a rule having priority 1. In this respect, it is assumed that the received rule is applied to egress traffic of 5-tuple interface 1, which has a source IP address of 10.1.1.1, a destination IP address of 10.1.1.2, source and destination ports of 23, and a protocol type of 6.

In the reference rule entry 410 of FIG. 6, it can be seen that a value of “10.1.1.1” is set for the source IP address 411, a value of “10.1.1.2” is set for the destination IP address 412, a value of “23” is set for the reception portion number 413, a value of “23” is set for the transmission port number 414, and a value of “6” is set for the protocol type 415. Also, a value of “1” is set for the priority field 416. The value of “1” is set for bit 0 of the interface bit map 511 of the auxiliary memory 500, and accordingly it can be appreciated that it is a rule for interface 1. The value of “1” is set for bit 0 of the direction bit map 512, and accordingly it can be appreciated that it is the egress traffic.

Meanwhile, in the interface ingress bit map 426 of the content rule entry 420, all bits are set to “0,” and a value of “X,” i.e. “Don't care,” is set for bit 0 of the interface egress bit map 427. Accordingly, it can be appreciated that the rule is applied to the egress traffic for interface 1.

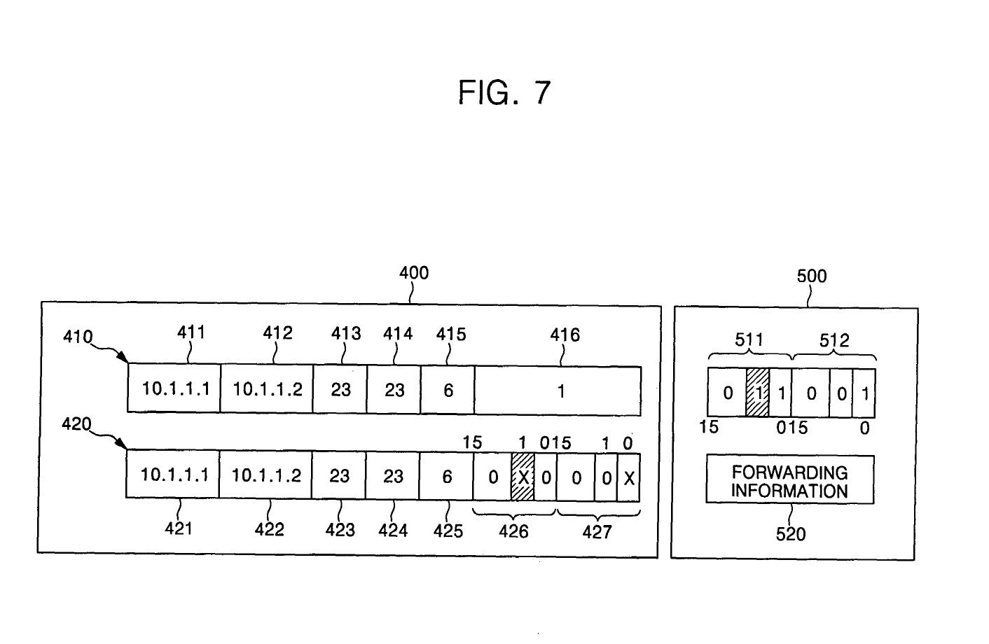

FIG. 7 is a diagram illustrating the change of a TCAM structure when a rule is added to a TCAM according to the present invention.

FIG. 7 illustrates the change of the TCAM when the 5-tuple (the source IP address: “10.1.1.1,” the destination IP address: “10.1.1.2,” the source and destination ports: “23,” and the protocol type: “6”) having priority 1 is applied to the ingress of interface 1 in the TCAM structure of FIG. 6.

Comparing the structure of FIG. 7 with that of FIG. 6, it can be appreciated that, in the interface bit map 511 of the auxiliary memory 500, the value of bit 1 is changed from “0” in FIG. 6 to “1” in FIG. 7, and that, in the interface ingress bit map 426 of the content rule entry 420 of the TCAM 400, the value of bit 1 is changed from “0” in FIG. 6 to “X (Don't care)” in FIG. 7. This represents that the rule is applied not only to the egress traffic of interface 0 but also to the ingress traffic of interface 1.

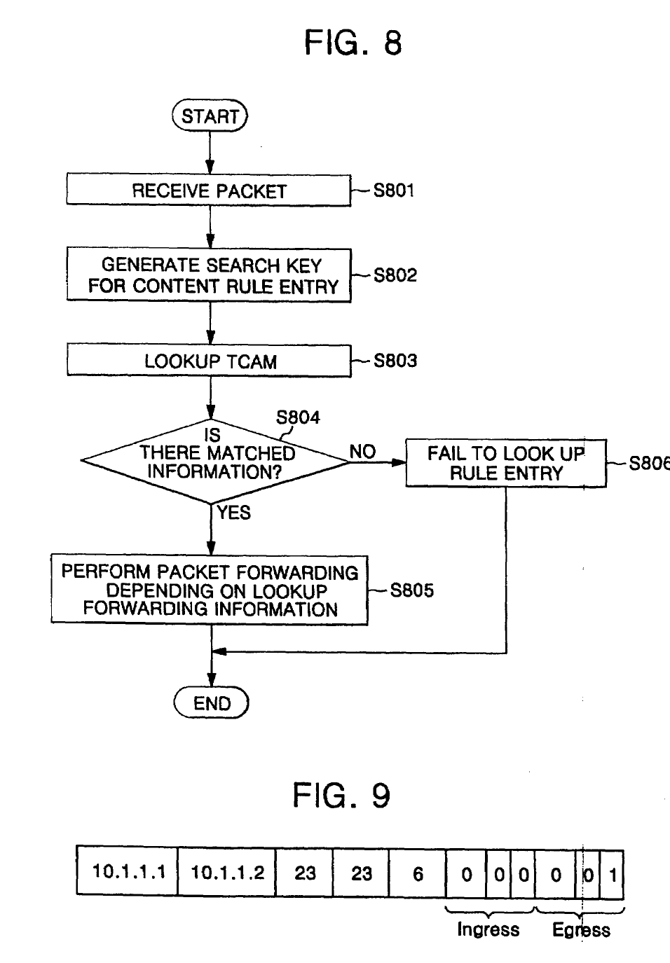

FIG. 8 is a flowchart of a lookup process of a routing system according to the present invention.

When a packet is received (Step 801), the routing system generates a search key for the content rule entry (Step 802). The structure of the search key for the content rule entry will be described in detail below with reference to FIG. 9. The routing system looks up the TCAM using the generated search key (Step 803), and searches to determine whether or not the matched entry exists (Step 804). If it is determined in Step 804 that the matched information exists, the routing system performs packet forwarding depending on the looked-up forwarding information (Step 805).

If it is determined in Step 804 that the matched information does not exist, the user is informed that the lookup of the content rule entry has failed (Step 806).

FIG. 9 is a diagram illustrating a search key structure for lookup according to an exemplary embodiment of the present invention.

The search key for the packet forwarding lookup of FIG. 9 has the same structure as the content rule entry 420 of the TCAM 400 described above. For packet forwarding, the received packet should be compared with the content stored in the content rule entry 420 because the content rule entry 420 interacts with the packet forwarding information 520 of the auxiliary memory 500.

In an exemplary embodiment of FIG. 9, there is shown the search key structure when the ingress traffic of interface 0 having a source IP address of “10.1.1.1,” a destination IP address of “10.1.1.2,” source and destination ports of “23,” and a protocol type of “6” is received. The search key of FIG. 9 is compared with the content rule entry of the TCAM. When the matched information exists, packet forwarding is performed on a corresponding packet based on the looked-up forwarding information.

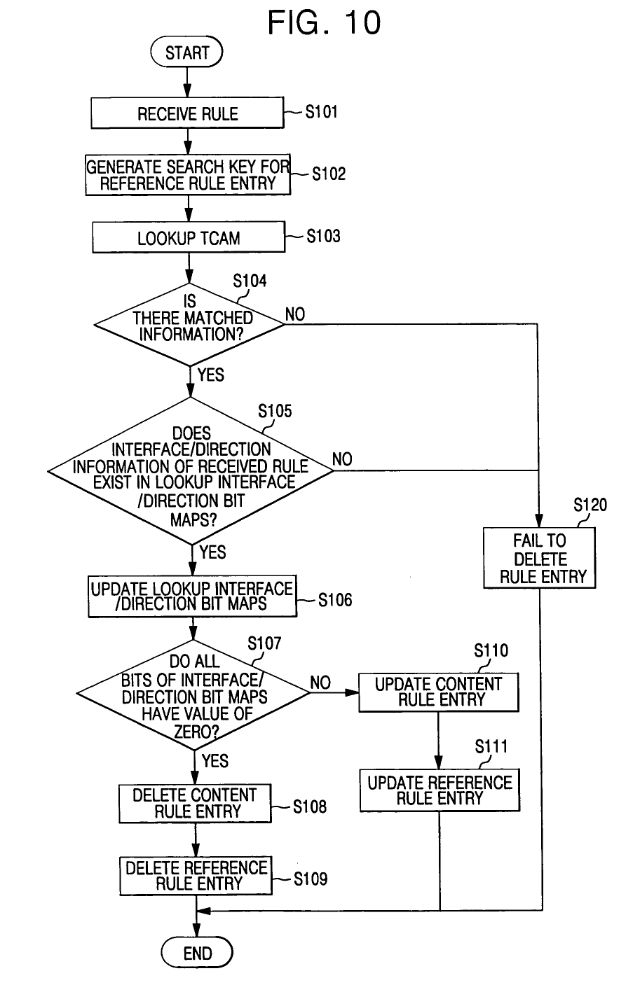

FIG. 10 is a flowchart of an operation of deleting the entry of a TCAM according to an exemplary embodiment of the present invention.

When information on a rule whose deletion is requested by the user is received (Step 101), the routing system generates the search key for the reference rule entry (Step 102). The routing system looks up the TCAM using the generated search key (Step 103), and searches to determine whether or not the matched entry exists (Step 104). When the matched information exists, it is determined whether or not the interface and direction information of the received rule exist in the looked-up interface bit map and direction bit map (Step 105). If it is determined that the interface and direction bit maps exist, the looked-up interface and direction bit maps of the auxiliary memory are updated (Step 106).

After updating of the auxiliary memory, it is determined whether or not all bits of the interface bit map and the direction bit map are “0” (Step 107). If it is determined that all bits of the bit maps are “0,” it is indicated that the entry is not needed. Therefore, the content rule entry is deleted (Step 108), and the reference rule entry is also deleted (Step 109). If it is determined in Step 107 that all bits of the interface direction bit map are not “0,” the content rule entry is updated (Step 110), and the reference rule entry is also updated (Step 111).

Meanwhile, in Step 104, if it is determined that the matched information does not exist, the user is informed that the deletion of the rule entry has failed (Step 120).

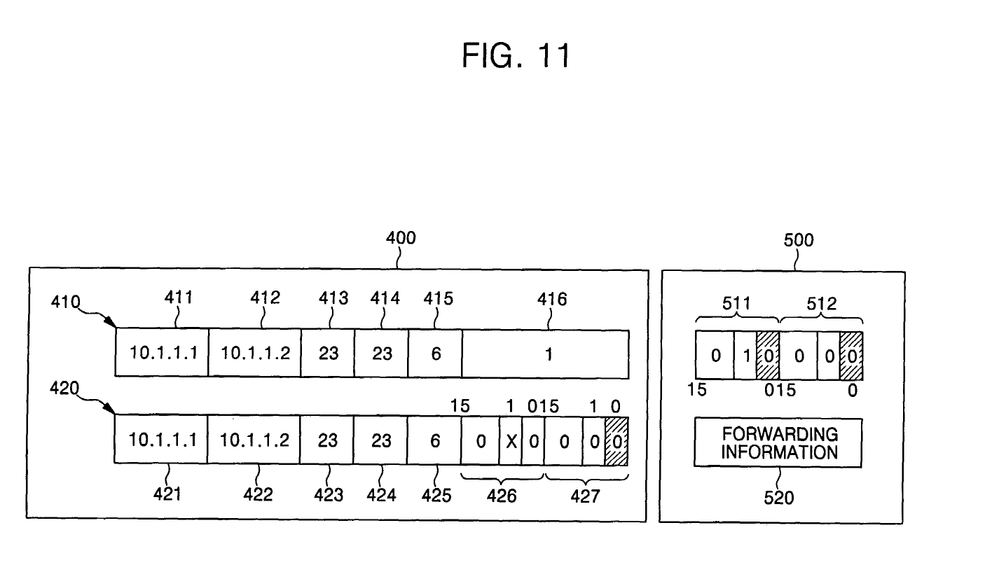

FIG. 11 illustrates the change of a TCAM based on deletion of an entry according to the present invention.

More specifically, FIG. 11 illustrates the change of the entry of the TCAM after the deletion of the rule in which the 5-tuple (the source IP address: “10.1.1.1,” the destination IP address: “10.1.1.2,” the source and destination ports: “23,” and the protocol type: “6”) having priority 1 is applied to the egress of interface 0.

As illustrated in FIG. 11, it can be appreciated that, in the interface bit map 511 of the auxiliary memory 500, the value of bit 0 is changed from “1” in FIG. 7 to “0” in FIG. 11 and, in the interface egress bit map 427 of the content rule entry 420 of the TCAM 400, the value of bit 0 is changed from “X” in FIG. 7 to “0” in FIG. 11.

In the present invention, when at least one rule having the same priority is applied to several interface packets, all rules can be expressed by only two entries, and the TCAM is effective in memory utilization.

While the present invention has been described with reference to exemplary embodiments thereof, it will be understood by those skilled in the art that various changes in form and detail may be made therein without departing from the scope of the present invention as defined by the following claims.

What is claimed is:

1. A routing system, comprising:
a ternary content addressable memory (TCAM) for classifying rule entries into a reference rule entry having both basic information and priority information about a packet to which a rule having a specific priority is applied, and a separate content rule entry having detailed information about a packet to which at least one rule having a same priority is applied, and for storing the classified rule entries; and
an auxiliary memory for storing interface bit map information and direction bit map information corresponding to the reference rule entry, and packet forwarding information corresponding to the content rule entry.

2. The routing system according to claim 1, wherein the priority information of the TCAM is information on priority between one of packet classification rules and packet filtering rules to be applied to one of an ingress interface and an egress interface, respectively.

3. The routing system according to claim 1, wherein the interface bit map information stored in the auxiliary memory is information on at least one of interfaces to which at least one rule having a same priority as the TCAM is applied.

4. The routing system according to claim 1, wherein the direction bit map information stored in the auxiliary memory is information on whether at least one of interfaces to which said at least one rule having a same priority as the TCAM is applied is one of an egress interface and an ingress interface.

5. The routing system according to claim 1, wherein the content rule entry comprises:
an interface ingress bit map indicating whether an interface to which a rule is applied processes ingress traffic; and
an egress bit map indicating whether the interface to which the rule is applied processes egress traffic.

6. The routing system according to claim 5, wherein, when the interface to which the rule is applied processes one of the ingress traffic and the egress traffic, a bit corresponding to a traffic direction of the interface is set to a value of “Don't care.”

7. The routing system according to claim 1, further comprising an entry manager for selectively adding and deleting one of the reference rule entry and the content rule entry of the TCAM.

8. The routing system according to claim 7, further comprising a lookup processor for obtaining packet forwarding information through TCAM lookup using a received packet and interface information on the received packet.

9. The routing system according to claim 7, further comprising a user interface for transmitting rule information which is inputted by a user to the entry manager and a lookup processor for packet classification, packet filtering, rule generation and deletion.

10. A ternary content addressable memory (TCAM), comprising:
a reference rule entry unit having basic information and priority information about a packet to which a rule having a specific priority is applied; and
a content rule entry unit having detailed information about a packet to which at least one rule having a same priority as the reference rule entry is applied.

11. The TCAM according to claim 10, wherein the priority information is information on priority between one of packet classification rules and packet filtering rules to be applied to one of an ingress interface and an egress interface, respectively.

12. The TCAM according to claim 10, wherein the content rule entry unit comprises:
an interface ingress bit map indicating whether an interface to which the rule is applied processes ingress traffic; and
an egress bit map indicating whether the interface to which the rule is applied processes egress traffic.

13. The TCAM according to claim 10, wherein, when an interface to which the rule is applied processes one of the ingress traffic and the egress traffic, a bit corresponding to a traffic direction of the interface is set to a value of “Don't care.”

14. A method for managing a rule entry for routing, the method comprising the steps of:
generating a reference rule entry of a ternary content addressable memory (TCAM) having basic information and priority information about a packet to which a rule having a specific priority is applied;
generating a content rule entry of the TCAM having detailed information about a packet to which at least one rule having a same priority is applied; and
storing, in an auxiliary memory, interface bit map information and direction bit map information corresponding to the reference rule entry, and packet forwarding information corresponding to the content rule entry.

15. The method according to claim 14, wherein the priority information of the TCAM is information on priority between one of packet classification rules and packet filtering rules to be applied to one of an ingress interface and an egress interface, respectively.

16. The method according to claim 14, wherein the interface bit map information is information on at least one of interfaces to which said at least one rule having a same priority as the TCAM is applied.

17. The method according to claim 14, wherein the direction bit map information is information on whether at least one of interfaces to which said at least one rule having a same priority as the TCAM is applied is one of an egress interface and an ingress interface.

18. The method according to claim 14, further comprising the steps of:
when there is a request to add a new rule, generating a search key for the reference rule entry; and
looking-up the TCAM using the search key, searching to determine whether a matched entry exists, and when the matched entry does not exist, and generating the reference rule entry and the content rule entry for the new rule requested to be added.

19. The method according to claim 14, further comprising the steps of:
when a request to delete a specific rule is inputted, generating a search key for the reference rule entry; and
looking-up the TCAM using the search key, searching to determine whether a matched entry exists, updating the reference rule entry and the content rule entry for the specific rule requested to be deleted when the matched entry exists, and deleting the reference rule entry and the content rule entry when all bits of an interface bit map and a direction bit map of the entry are “0.”

20. The method according to claim 14, further comprising the steps, when a packet for routing lookup is received, of:
generating a search key for the content rule entry; and
looking-up the TCAM using the search key, searching to determine when a matched entry exists, and when a matched entry exists, performing packet forwarding on the received packet depending on forwarding information stored in the auxiliary memory.
